(19) United States
(12) Patent Application Publication
(10) Pub. No.: US 2023/0076581 A1
(43) Pub. Date: Mar. 9, 2023

(54) HEATING ASSEMBLY AND HEATING ATOMIZATION APPARATUS

(71) Applicant: SHENZHEN SMOORE TECHNOLOGY LIMITED, Shenzhen (CN)

(72) Inventors: Jiao ZHANG, Shenzhen (CN); Jinxing DENG, Shenzhen (CN); Hongming ZHOU, Shenzhen (CN)

(21) Appl. No.: 17/985,741

(22) Filed: Nov. 11, 2022

Related U.S. Application Data
(63) Continuation of application No. PCT/CN2021/093390, filed on May 12, 2021.

(30) Foreign Application Priority Data
May 15, 2020 (CN) 202010414984.3

(51) Int. Cl. A24F 40/46

(52) U.S. Cl. CPC A24F 40/46

(57) ABSTRACT

A heating assembly includes: a heating element having a substrate and a heating region, an overlapping region and a conductive region being located on the substrate and sequentially distributed in an axial direction of the substrate and connected, the heating region being provided with a heating circuit which extends to the overlapping region, and the conductive region being provided with a conductive circuit which extends to the overlapping region and is connected with the heating circuit in an overlapping manner or in parallel; and a fixing base, one end of the fixing base fixing the heating element, the fixing base being at least partially in contact with the overlapping region.

### CROSS-REFERENCE TO PRIOR APPLICATION

This application is a continuation of International Patent Application No. PCT/CN2021/093390, filed on May 12, 2021, which claims priority to Chinese Patent Application No. 202010414984.3, filed on May 15, 2020. The entire disclosure of both applications is hereby incorporated by reference herein.

### FIELD

The present invention relates to the technical field of vaporization, and particularly relates to a heating assembly and a heating vaporization device.

### BACKGROUND

With the popularization of the concept of health, heat-not-burn vaporization devices tend to be popular. Heat-not-burn vaporization means that specially-made plant leaf substances and aroma components added to plant leaves are evaporated in the form of aerosols under heating and baking at 300° C. without ignition by an open flame to be inhaled by a person so that a smoker can have the corresponding mouthfeel.

A core part forming the aerosols in a heat-not-burn manner is a heating element which bakes the aerosol-forming substrate such as plant leaves after a temperature rise. However, in order to meet the requirement during heating, the temperature of the heating element may become very high, which increases difficulty for fixing the heating element.

### SUMMARY

In an embodiment, the present invention provides a heating assembly, comprising: a heating element comprising a substrate and a heating region, an overlapping region and a conductive region being located on the substrate and sequentially distributed in an axial direction of the substrate and connected, the heating region being provided with a heating circuit which extends to the overlapping region, and the conductive region being provided with a conductive circuit which extends to the overlapping region and is connected with the heating circuit in an overlapping manner or in parallel; and a fixing base, one end of the fixing base fixing the heating element, the fixing base being at least partially in contact with the overlapping region.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic structural diagram of a first embodiment of a heating assembly of the present invention;

FIG. 2 is a schematic structural diagram of a second embodiment of a heating assembly of the present invention;

FIG. 3 is a schematic structural diagram of a third embodiment of a heating assembly of the present invention;

FIG. 4 is a schematic structural diagram of a fourth embodiment of a heating assembly of the present invention;

FIG. 5a and FIG. 5b are schematic structural diagrams of a first embodiment of two surfaces of a heating film in a columnar substrate;

FIG. 5c is a schematic structural diagram of at least one surface in a sheet-like substrate;

FIG. 6a and FIG. 6b are schematic structural diagrams of a second embodiment of two surfaces of a heating film in a columnar substrate;

FIG. 6c is a schematic structural diagram of a third embodiment of one surface of a heating film in a columnar substrate;

FIG. 7a and FIG. 7b are schematic structural diagrams of a fourth embodiment of two surfaces of a heating film in a columnar substrate; and

FIG. 8 is a schematic structural diagram of one embodiment of a heating vaporization device of the present invention.

### DETAILED DESCRIPTION

In an embodiment, the present invention provides a heating assembly and a heating vaporization device, wherein a fixing base is fixed in an overlapping region, which improves the electrical connection stability of a heating circuit and a conductive circuit.

In an embodiment, the present invention providea heating assembly, including: a heating element, the heating element including a substrate and a heating region, an overlapping region and a conductive region located on the substrate and sequentially distributed in the axial direction of the substrate and connected, wherein the heating region is provided with a heating circuit which extends to the overlapping region, and the conductive region is provided with a conductive circuit which extends to the overlapping region and is connected with the heating circuit in an overlapping manner or in parallel; and a fixing base, one end of the fixing base fixing the heating element, and the fixing base being at least partially in contact with the overlapping region.

The substrate is a sheet-like substrate; or the substrate is a columnar substrate.

The temperature of the overlapping region during heating is lower than the temperature of the heating region and the conductive region during heating.

The heating circuit of the overlapping region is stacked on the conductive circuit of the overlapping region.

The fixing base further includes a flange plate and a base, wherein the flange plate has a through groove at the middle position, the heating element penetrates through the through groove to fix the flange plate at least partially to the overlapping region of the heating element, and the flange plate fixes the heating element to the base.

The flange plate is completely in contact with the overlapping region.

The outer side of the columnar substrate is wrapped with a heating film, and the heating region, the overlapping region and the conductive region are disposed on the surface of the heating film close to the substrate; and the surface of the heating film away from the substrate is provided with a conductive disc corresponding to the conductive region; corresponding to the conductive region, the conductive disc has a through hole penetrating through the heating film, and the through hole has a conductive substance therein so as to electrically connect the conductive disc with the conductive circuit in the conductive region.

One surface of the sheet-like substrate is provided with the heating region, the overlapping region and the conductive region, and the conductive disc, wherein the conductive disc is located on the side of the conductive region away from the heating region.

The heating circuit includes a first heating circuit, the conductive circuit includes a first conductive circuit, and the first heating circuit and the first conductive circuit coincide in the overlapping region, wherein the first heating circuit is distributed in a U shape, and the first conductive circuit is connected to both ends of the U-shaped first heating circuit; and the conductive disc includes a first positive conductive disc and a first negative conductive disc, and the first positive conductive disc and the first negative conductive disc are respectively connected to the end of the first conductive circuit away from the first heating circuit.

The heating circuit further includes a second heating circuit, the conductive circuit further includes a second conductive circuit, and the second heating circuit and the second conductive circuit coincide in the overlapping region, wherein the second heating circuit is distributed in a U shape, and the second conductive circuit is connected to both ends of the U-shaped second heating circuit; and the conductive disc includes a second positive conductive disc and a second negative conductive disc, and the second positive conductive disc and the second negative conductive disc are respectively connected to the end of the second conductive circuit away from the second heating circuit.

The first heating circuit is one circuit connected in series with the first conductive circuit, and the second heating circuit and the second conductive circuit are located on the inner side of the first heating circuit and the first conductive circuit; or the first heating circuit is a plurality of circuits connected in parallel with the first conductive circuit, and the second heating circuit and the second conductive circuit are located between the plurality of first heating circuits and the first conductive circuit.

The first heating circuit and the second heating circuit share the first positive conductive disc or the second positive conductive disc; or the first heating circuit and the second heating circuit share the first negative conductive disc or the second negative conductive disc.

The sheet-like substrate and the columnar substrate each include a base portion and a pointed portion located at one end of the base portion, and the heating region is close to the pointed portion.

The end of the base portion of the columnar substrate away from the pointed portion has a groove body concaving inwards.

The side of the heating region, the overlapping region and the conductive region away from the substrate is provided with a covering protective layer, and the protective layer exposes a part of the conductive region.

The end of the conductive disc away from the heating circuit is further connected with an electrode lead, and the electrode lead is used for connecting with a power supply device, thereby connecting the heating element with the power supply device.

Two surfaces of the sheet-like substrate are each provided with an insulating layer, and the heating region, the overlapping region and the conductive region, and the conductive disc are disposed on the insulating layer on one surface of the substrate.

The thickness of the heating film is 0.02-0.5 mm; or the thickness of the heating film is 0.05-0.2 mm.

The resistance of the first heating circuit is 0.5-2 ohms; and/or the resistance of the second heating circuit is 5-20 ohms.

The resistivity of the second heating circuit located in the heating region is greater than the resistivity of the first heating circuit located in the heating region; and/or the resistance of the first heating circuit located in the conductive region is equal to the resistance of the second heating circuit located in the conductive region.

In order to solve the above technical problem, the second technical solution provided by the present invention is to provide a heating vaporization device, including: a heating assembly and a power supply device, wherein the heating assembly is the heating assembly according to any one of the above; and the power supply device is connected to the heating assembly to supply power to the heating assembly.

The present invention has the beneficial effects as follows: different from the prior art, in the heating assembly proposed in the present invention, the fixing base is fixed to the overlapping region of the heating circuit and the conductive circuit so as to guarantee the electrical connection stability of the heating circuit and the conductive circuit while fixing the heating assembly.

The technical solutions in embodiments of the present invention are clearly and completely described below with reference to the accompanying drawings in the embodiments of the present invention. Apparently, the described embodiments are merely some rather than all of the embodiments of the present invention. All other embodiments obtained by a person of ordinary skill in the art based on the embodiments of the present invention without creative efforts shall fall within the protection scope of the present invention.

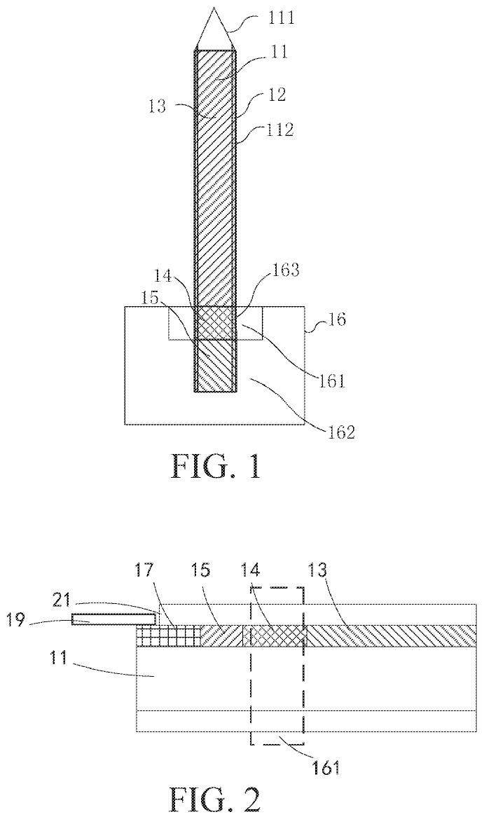

Referring to FIG. 1, it is a schematic structural diagram of a first embodiment of a heating assembly provided by the present invention. The heating assembly includes a heating element and a fixing base. The heating element includes a substrate 11, the substrate 11 can be columnar and can also be sheet-like, which is not limited specifically. As shown in FIG. 1, the substrate 11 of the heating element is a columnar substrate, and a heating region 13, an overlapping region 14 and a conductive region 15 are sequentially distributed in the axial direction of the substrate 11 from top to bottom and connected. Specifically, if the substrate 11 is the columnar substrate, a heating film 12 is disposed on the surface of the substrate 11, the heating film 12 surrounds the outer side of the substrate 11 and covers the substrate 11, and the heating film 12 is located in the heating region 13, the overlapping region 14 and the conductive region 15. Specifically, when the heating film 12 wraps the columnar substrate 11, the heating region 13, the overlapping region 14 and the conductive region 15 on the heating film 12 are in contact with the outer surface of the substrate 11, namely, the heating region 13, the overlapping region 14 and the conductive region 15 are located on the surface of the heating film 12 close to the substrate 11. In one embodiment, the substrate 11 may be a ceramic substrate whose material is zirconium oxide, aluminum oxide ceramic, etc. The substrate 11 employs a ceramic material, which can provide rigid mechanical supporting and uniform heat conduction for the heating region 13 of the heating film 12 and prevent the breakage or the uneven heat distribution thereof. Specifically, the heating region 13, the overlapping region 14 and the conductive region 15 are disposed on one surface of the heating film 12, the heating film 12 is disposed on the surface of the substrate 11 by sintering, and the heating region 13, the overlapping region 14 and the conductive region 15 are made to be close to the surface of the substrate 11. Since the heating film 12 is formed on the outer side of the substrate 11 having a small diameter by winding, in order to prevent the heating film 12 from being broken, the heating film 12 needs to have a small thickness, and in one specific embodiment, the thickness of the heating film 12 is 0.02-0.5 mm, and further, the thickness of the heating film may also be 0.05-0.2 mm.

In one embodiment, the material of the heating film 12 is different from the material of the substrate 11, and a flexible thin film can be formed by a casting process; the composition of the heating film 12 can be one of or any combination of microcrystalline glass, glass-ceramic (such as calcium borosilicate glass-silicon oxide), low-temperature ceramic (tin-barium borate ceramic and zirconium-barium borate ceramic), which can be sintered below 1000° C.; and in one embodiment, the material of the heating film 12 is preferably a glass-ceramic material.

Further, the surface of the heating film 12 away from the substrate 11 is further provided with a conductive disc 17 connected to the conductive region 15 for connection with an external power supply device, thereby connecting the heating element with the power supply device, so that the power supply device supplies power to the heating element.

Further, the end of the conductive disc 17 away from the heating region 13 is provided with an electrode lead 19 for connection with the power supply device through the electrode lead 19, thereby connecting the heating element with the power supply device.

As shown in FIG. 2, the substrate 11 of the heating element is a sheet-like substrate, and the substrate 11 may be made from a conductive material or a non-conductive insulating material. Specifically, as shown in FIG. 2, the substrate 11 is made from the non-conductive insulating material and may have a thickness of 0.2-0.8 mm, and preferably, the thickness of the substrate 11 is 0.3-0.6 mm. If the substrate 11 is made from the insulating material, the heating region 13, the overlapping region 14 and the conductive region 15 may be disposed directly on one surface of the substrate 11, and the conductive disc 17 may be disposed on the side of the conductive region 15 away from the heating region 13 and connected to the conductive region 15. Further, since the substrate 11 is the sheet-like substrate, and the heating region 13, the overlapping region 14 and the conductive region 15 are exposed, the side of the heating region 13, the overlapping region 14 and the conductive region 15 away from the substrate 11 is further provided with a protective layer 21 covering the heating region 13, the overlapping region 14 and the conductive region 15, the conductive region 15 is partially exposed by the protective layer 21, and the exposed part of the conductive region 15 is used for connecting the electrode lead 19, and then connecting the power supply device via the electrode lead 19, and then connecting the heating element with the power supply device.

In one embodiment, the protective layer 21 can be a glaze layer, which can insulate the heating region 13, the overlapping region 14 and the conductive region 15 from the outside air, and prevent oxidation when the temperature of the heating region 13 is high, so that the heating region 13 maintains a good heating effect for a long period of time, which further prolongs the service life of the heating element and improves the stability of the heating element, while reducing the surface roughness of the heating element.

In one embodiment, when the electrode lead 19 connected to the conductive disc 17 is disposed, the conductive disc 17 may be connected to the electrode lead 19 by high-temperature soldering at 600-1100° C. through argentum-copper solder. It is also possible to weld the electrode lead 19 to the position of the conductive disc 17 by tin soldering through high-temperature soldering paste (use temperature greater than 300° C.).

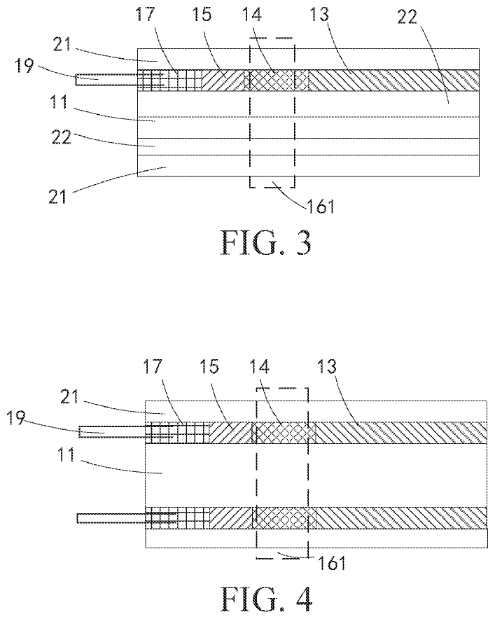

In one embodiment, the substrate 11 may be made from the conductive material, as shown in FIG. 3, and it differs from the embodiment shown in FIG. 2 in that: the substrate 11 is made from the conductive material. Specifically, the substrate 11 may be made from a general metal material such as stainless steel and a titanium alloy, because the metal material has good toughness, can be resistant to high temperature and mechanical impact for a long time, has good heat conduction at the same time, and can make the overall temperature of the heating element uniform. In one embodiment, the material of the substrate 11 is preferably stainless steel, such as one of stainless steels including 430 and 304.

In a preferred embodiment, the substrate 11 is made from a metal material, the metal material has a high mechanical strength so as to effectively prevent the heating element from being broken under high temperature and mechanical impact for a long period of time, and at the same time, the metal material has good heat-conducting property, which ensures the uniformity of the surface temperature of the heating element, and facilitates acquiring a good mouthfeel from the heat-not-burn substrate.

Specifically, when the substrate 11 is made from the conductive material, it is needed to dispose insulating layers 22 on both surfaces of the substrate 11 before the heating region 13, the overlapping region 14 and the conductive region 15 are disposed, and the heating region 13, the overlapping region 14 and the conductive region 15 are disposed on the insulating layer 22. In one embodiment, the material of the insulating layer 22 is a glass layer having aluminum oxide and calcium oxide as main components, and can make the substrate 11 non-conductive and prevent the situation that due to the conductivity of the substrate 11, a conductive path of the heating region 13, the overlapping region 14 and the conductive region 15 is short-circuited. The insulating layer 22 may be formed by spraying or silk screen printing by covering paste of the insulating layer 22 on the surface of the substrate 11 and then firing. The thickness of the insulating layer 22 can be designed according to the withstanding voltage requirement between the conductive path and the substrate 11. In one embodiment, the thickness of the insulating layer 22 may be set to be less than 0.1 mm.

In one embodiment, the insulating layer 22 may be disposed on one surface of the substrate 11 where the heating region 13, the overlapping region 14, and the conductive region 15 are disposed, and is not disposed on the other surface. Specifically, as shown in FIG. 3, in the present embodiment, only one surface of the substrate 11 is provided with the heating region 13, the overlapping region 14 and the conductive region 15, and therefore, the insulating layer 22 may be disposed only on one surface of the substrate 11. In another embodiment, even if only one surface of the substrate 11 is provided with the heating region 13, the overlapping region 14 and the conductive region 15, the insulating layer 22 may be disposed on both surfaces of the substrate 11 so as to prevent the surface of the substrate 11 from being oxidized at a high temperature, the insulating layer 22 is disposed, and the insulating layer 22 protects the substrate 11 against air.

In the embodiments shown in FIG. 2 and FIG. 3, only one surface of the substrate 11 is provided with the heating region 13, the overlapping region 14 and the conductive region 15, and in one embodiment, the heating region 13, the overlapping region 14 and the conductive region 15 may also be disposed on both surfaces of the substrate 11, specifically as shown in FIG. 4. Both surfaces of the substrate 11 are provided with the heating region 13, the overlapping region 14 and the conductive region 15. Specifically, same as the embodiment shown in FIG. 2, the substrate 11 may be likewise made from the non-conductive and insulating material, and same as the embodiment shown in FIG. 3, the substrate 11 may be likewise made from the conductive material. If the substrate 11 is made from the conductive material, same as what is shown in FIG. 3, the insulating layer 22 is disposed on both surfaces of the substrate 11, and then the heating region 13, the overlapping region 14 and the conductive region 15 are disposed on the insulating layer 22.

In the present embodiment, since both sides of the substrate 11 are each provided with the heating region 13, the overlapping region 14 and the conductive region 15, considering the influence of the heating temperature, the thickness of the substrate 11 can be set to be 2 times or more than 2 times the thickness of the substrate 11 in the embodiments shown in FIG. 2 and FIG. 3, which is not limited specifically.

Specifically, if the substrate 11 is the columnar substrate, the surface of the substrate is provided with the heating film 12, the surface of the heating film 12 close to the substrate 11 is provided with the heating region 13, the overlapping region 14 and the conductive region 15, the surface of the heating film 12 away from the substrate 11 is provided with the conductive disc 17, one end of the conductive disc 17 away from the heating region 13, the overlapping region 14 and the conductive region 15 is provided with the electrode lead 19 connected to the conductive region 15, and the electrode lead 19 is connected to the power supply device. If the substrate 11 is the sheet-like substrate and conductive, at least one surface of the substrate 11 is provided with the insulating layer 22, and the heating region 13, the overlapping region 14 and the conductive region 15 are disposed on the surface of the insulating layer 22 away from the substrate 11; and if the substrate 11 is non-conductive and insulating, the heating region 13, the overlapping region 14 and the conductive region 15 are disposed on the substrate 11. On the surface where the heating region 13, the overlapping region 14 and the conductive region 15 are disposed, the conductive disc 17 is disposed at the end of the conductive region 15 away from the heating region 13, the protective layer 21 is further disposed on the surface of the heating region 13, the overlapping region 14 and the conductive region 15 away from the substrate 11, a part of the conductive region 15 is exposed by the protective layer 21, the electrode lead 19 is disposed at the end of the exposed part away from the heating region 13, and the electrode lead 19 is connected to the power supply device. The substrate 11 may be provided with the heating region 13, the overlapping region 14 and the conductive region 15 on one side, and may also be provided with the heating region 13, the overlapping region 14 and the conductive region 15 on both sides, which is not limited specifically.

The heating assembly as described in FIG. 1 to FIG. 4 further includes a fixing base 16 for fixing the heating element. Specifically, in one embodiment, the temperature of the heating region 13 during heating is higher than the temperature of the overlapping region 14 and the conductive region 15, and further, the temperature of the overlapping region 14 during heating is lower than the temperature of the conductive region 15, i.e. the temperature of the overlapping region 14 is the lowest when the heating element performs heating. In a specific embodiment, the fixing base 16 is fixed at the position of the overlapping region 14 of the heating element, and further the fixing base 16 is at least partly in contact with the overlapping region 14.

Specifically, the fixing base 16 includes a flange plate 161 and a base 162. The flange plate 161 has a through groove 163 at the middle position, the heating element penetrates through the through groove 163 to fix the flange plate 161 at least partially to the overlapping region 14 of the heating element, and the flange plate 161 fixes the heating element to the base 162. Specifically, the flange plate 161 of the fixing base 16 is at least partially installed in the overlapping region 14, the other part is installed in the conductive region 15, i.e. the flange plate 161 of the fixing base 16 is not installed in the heating region 13, which is advantageous to balance the temperature uniformity of the heating region, and the conductive region 15 is fixed in the fixing base 16, which can reduce the heating and energy loss. In one embodiment, if the size of the overlapping region 14 is sufficient, the flange plate 161 may also be completely disposed in the overlapping region 14, thereby completely housing the conductive region 15 in the base 162 to further reduce the heating and energy loss of the conductive region. In one embodiment, the overlapping region 14 may be completely in contact with the flange plate 161, or alternatively, the overlapping region 14 may be partially in contact with the flange plate 161 such that the flange plate 161 is completely located in the overlapping region 14.

In one embodiment, a heating circuit is correspondingly disposed in the heating region 13, a conductive circuit is disposed in the conductive region 15, and the heating circuit coincides with the conductive circuit in the overlapping region 14. The heating circuit may be one or more, may be connected in parallel or may be connected in series; and the conductive circuit is disposed corresponding to the heating circuit, and can be disposed according to a connection end formed by the heating circuit, for example, one conductive circuit is connected to one connection end of the heating circuit.

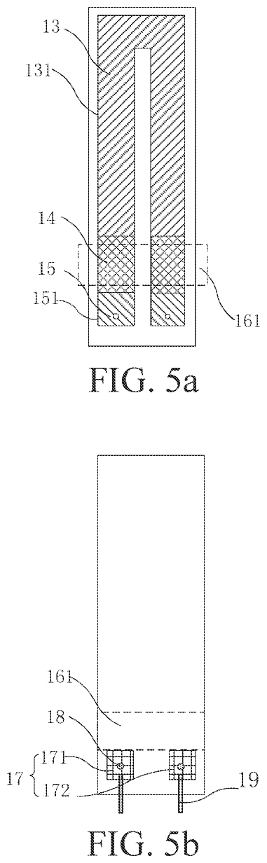

Specifically, please refer to FIG. 5a, FIG. 5b and FIG. 5c, and FIG. 5a and FIG. 5b are schematic structural diagrams of two surfaces of a heating film in a columnar substrate as shown in FIG. 1. FIG. 5c is a schematic structural diagram of at least one surface in a sheet-like substrate as shown in FIG. 2 to FIG. 4. The heating region 13 is provided with the heating circuit which extends to the overlapping region 14; the conductive region 15 is provided with the conductive circuit which extends to the overlapping region 14 and is connected with the heating circuit in an overlapping manner or in parallel; and overlapping connection means that one is located above the other, and parallel connection means that the two are disposed horizontally in parallel and connected via an edge. Specifically, when the heating circuit and the conductive circuit are connected in the overlapping manner in the overlapping region 14, the heating circuit may be disposed above the conductive circuit or the conductive circuit may be disposed above the heating circuit. If the heating circuit and the conductive circuit are connected in parallel in the overlapping region 14, the heating circuit and the conductive circuit can be disposed separately, and the edge of the heating circuit and the edge of the conductive circuit can be connected, or the heating circuit and the conductive circuit can also be disposed crosswise, and the edge of the heating circuit and the edge of the conductive circuit can be connected, which is not limited specifically.

Specifically, please refer to FIG. 5a, the heating region 13 is provided with one heating circuit, i.e. a first heating circuit 131. Specifically, the first heating circuit 131 is distributed in a U shape in the heating region 13 and the overlapping region 14 of the substrate 11, so that the first heating circuit 131 has two connection ends in the overlapping region 14. In the present embodiment, the conductive circuit includes a first conductive circuit 151, the first conductive circuit 151 is respectively connected to both ends of the first heating circuit 131 distributed in a U shape, and two ends of the first heating circuit 131 distributed in a U shape are not connected to the first conductive circuit 151. The first conductive circuit 151 extends from the conductive region 15 to the overlapping region 14, and coincides with both connection ends of the first heating circuit 131 in the overlapping region 14. In one embodiment, the heating region overlapping with the overlapping region is located above the conductive circuit.

In one embodiment, the first heating circuit 131 is a resistance heating circuit that generates Joule heat when a current passes through to cause the temperature of the heating element to rise, thereby heating the heat-non-burn substrate. In one embodiment, the first heating circuit 131 may transfer electronic paste to the heating film 12 by silk screen printing of thick film paste, and then the heating film 12 is sintered onto the substrate 11. Specifically, in the present embodiment, when the substrate 11 is wrapped with the heating film 12, only a base portion 112 of the substrate 11 is wrapped with the heating film, whereby when the substrate 11 is the columnar substrate, the heating region 13 is not distributed on a pointed portion 111 thereof.

In one embodiment, the resistance value of the first heating circuit 131 may be between 0.5 ohm and 2 ohms in order to match a commonly used power supply device, thereby enabling the heating element to acquire higher heating power. Specifically, the resistance value of the first heating circuit 131 may be set according to the material of the electronic paste, the length, width and thickness of the heating circuit, and the shape of a pattern, and is not limited herein. In order to make the temperature on the heating element relatively uniform, so that a larger amount of aerosol and a good mouthfeel can be acquired when heating the heat-not-burn substrate, and the energy is fully utilized, the circuits located in different regions are made from different materials, specifically, for example, in one embodiment, the resistivity coefficient of the first heating circuit 131 in the heating region 13 is different from the resistivity coefficient of the first conductive circuit 151 in the conductive region 15. Specifically, the resistivity coefficient of the material of the first heating circuit 131 disposed in the heating region 13 is greater than the resistivity coefficient of the material of the first conductive circuit 151 located in the conductive region 15. For example, the material of the first heating circuit 131 located in the heating region 13 is a high-resistance conductive paste, for example, a metal or alloy having a relatively high resistivity with Ni (nickel), Ag—Pd (argentum-palladium), Ag—Pt (argentum-platinum), and Ag—RuO (argentum-ruthenium oxide) as a main conductive component and a high-proportion inorganic binder are used. The material of the first conductive circuit 151 located in the conductive region 15 is a low-resistivity conductive paste, for example, a metal or alloy having a relatively low resistivity with Ag (argentum) and Au (aurum) as a main conductive component and a low-proportion inorganic binder are used.

In one embodiment, since the high conductive metal such as Ag (argentum) and Au (aurum) has a low melting point (Tc (Ag) about 960° C. and Tc (Au) about 1064° C.), it needs to be sintered at a temperature of 1000° C. or less, whereas conventional ceramics (aluminum oxide, and aluminum nitride) generally have a sintering temperature of 1400-1600° C., and therefore, the low-resistivity material of the first heating circuit 131 located in the overlapping region 14 can be disposed according to the heating film 12.

In one embodiment, the respective resistances may be set according to the shapes of the heating circuit and the conductive circuit, but the region where the heating circuit and the conductive circuit overlap is minimum regardless of the resistance values of the heating circuit and the conductive circuit.

In one embodiment, the lengths of the first heating circuit 131 and the first conductive circuit 151 can be flexibly controlled, and generally, the first heating circuit 131 is distributed in the heating region 13 from bottom to top and then from top to bottom, for example, distribution in a U shape shown in FIG. 5a, thereby enabling the heating region 13 of the heating element to have good temperature uniformity.

In one embodiment, the sheet-like substrate and the columnar substrate include a base portion 112 and a pointed portion 111 located at one end of the base portion 112, and the heating region 13 is close to the pointed portion 111. Specifically, the substrate 11 is provided with the pointed portion 111 to facilitate insertion of the heating element into the heat-not-burn substrate.

Please refer to FIG. 5b, the surface of the heating film 12 away from the substrate 11 has the conductive disc 17, and as shown in FIG. 5b, the conductive disc 17 is disposed corresponding to the conductive region 15. Specifically, the conductive disc 17 includes a first positive conductive disc 171 and a first negative conductive disc 172, and the first positive conductive disc 171 and the first negative conductive disc 172 are respectively connected to the end of the first conductive circuit 151 away from the first heating circuit 131. Specifically, the first positive conductive disc 171 and the first negative conductive disc 172 have a through hole 18 penetrating through the heating film 12 at a position corresponding to the first conductive circuit 151, and the through hole 18 is filled with a conductive substance, thereby electrically connecting the first positive conductive disc 171 and the first negative conductive disc 172 with the first conductive circuit 15 respectively. Further, the electrode lead 19 is further disposed on the same surface of the heating film 12 and the conductive disc 17, the electrode lead 19 is connected to the conductive disc 17, specifically, one end of the electrode lead 19 is connected to the first positive conductive disc 171 and the first negative conductive disc 172, respectively, the other end of the electrode lead 19 is connected to the power supply device, and then the heating element is connected to the power supply device.

Please refer to FIG. 5c which is a schematic structural diagram of at least one surface of a sheet-like substrate. Specifically, the sheet-like substrate 11 also includes a base portion 112 and a pointed portion 111. In the present embodiment, the heating region 13 is distributed on the pointed portion 111 of the substrate 11, and specifically, the pointed portion 111 is provided with the first heating circuit 131. Further, the difference from FIG. 5a lies in that in the present embodiment, the conductive disc 17, the heating region 13, the overlapping region 14 and the conductive region 15 are disposed on the same surface of the substrate 11, and specifically, same as what is shown in FIG. 5a, the first heating circuit 131 is distributed in a U shape, and the first conductive circuit 151 is connected to both ends of the first heating circuit 131 distributed in a U shape. The conductive disc 17 includes a first positive conductive disc 171 and a first negative conductive disc 172, the first positive conductive disc 171 and the first negative conductive disc 172 are connected to the end of the first conductive circuit 151 away from the first heating circuit 131, and the electrode lead 19 is connected to the end of the first positive conductive disc 171 and the first negative conductive disc 172 away from the first conductive circuit 151, which further connects the heating element to the power supply device.

Specifically, in the present embodiment, the first heating circuit 131 and the first conductive circuit 151 can be deposited on the substrate 11 or on the insulating layer 22 covering the surface of the substrate 11 through PVD (physical vapor deposition) or electroplating, and can also be formed by printing a conductive paste on the substrate 11 or on the insulating layer 22 covering the surface of the substrate 11 through silk screen printing, and then firing; and it is preferable to use manners of silk screen printing and sintering, the first heating circuit 131 can use a noble metal paste such as a commonly used argentum-palladium resistance paste, a ruthenium-palladium resistance paste and a platinum paste, and can also use a base metal paste such as a nickel base, and the first conductive circuit 151 can use an argentum-based paste with a relatively low resistivity. The pattern of the first heating circuit 131 can be flexibly set, in combination with the properties of the conductive paste and the thickness of the first heating circuit 131, so as to obtain a suitable resistance value required for the heating element, and the resistance value of the heating element is generally between 0.3-2.0 Ω; and the thickness of the first heating circuit 131 is generally less than 0.1 mm, preferably less than 20 μm.

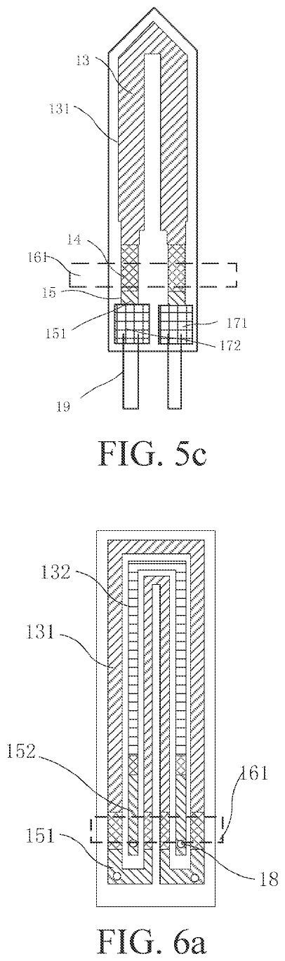

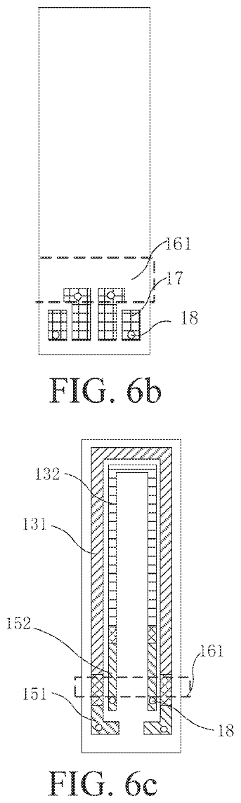

Please refer to FIG. 6a, as compared with the embodiment shown in FIG. 5a, the difference lies in that a plurality of first heating circuits 131 are included in the present embodiment, and the plurality of first heating circuits 131 are disposed in parallel. Specifically, the plurality of first heating circuits 131 are all distributed in a U shape in the heating region 13 and the overlapping region 14, and the first conductive circuits 151 are distributed in the conductive region 15 and the overlapping region 14. The first conductive circuit 151 is connected to the first heating circuit 131 in the overlapping region 14, and two first heating circuits 131 are connected in parallel by the first conductive circuit 151. Specifically, in the present embodiment, a second heating circuit 132 and a second conductive circuit 152 are further included. In one embodiment, the second heating circuit 132 and the second conductive circuit 152 are located on the inner side of the first heating circuit 131 and the first conductive circuit 151, and further, the second heating circuit 132 and the second conductive circuit 152 are located between the plurality of first heating circuits 131 connected in parallel. As shown in FIG. 6a, in one embodiment, positions of the heating region 13, the overlapping region 14 and the conductive region 15 at the position where the second heating circuit 132 is located may correspond to positions of the heating region 13, the overlapping region 14 and the conductive region 15 at the position where the first heating circuit 131 is located, and the positions may also be staggered, for example, as shown in FIG. 6a, the positions of the heating region 13, the overlapping region 14 and the conductive region 15 at the position where the second heating circuit 132 is located may be staggered from the positions of the heating region 13, the overlapping region 14 and the conductive region 15 at the position where the first heating circuit 131 is located.

In one embodiment, the second heating circuit 132 may be a temperature measurement circuit, which has a TCR characteristic of a resistance, namely, there is a specific correspondence between the temperature and the resistance; and when the second heating circuit 132 is externally connected to a certain power supply device via the second conductive circuit 152, and when a certain voltage is applied, a specific current value is obtained, so as to obtain a resistance value of the second conductive circuit 152, and then the current temperature of the second conductive circuit 152 is deduced.

In one embodiment, the first heating circuit 131 may also have the TCR characteristic. In the present embodiment, disposing the second heating circuit 132 has the advantageous that the second heating circuit 132 has little self-heating and few noise signals are introduced during current heating, which facilitates accurate control over the temperature by the electronic element. Meanwhile, since the second heating circuit 132 does not need to be heated, the initial resistance value thereof is generally larger than that of the first heating circuit 131. At room temperature, the resistance value of the second heating circuit 132 may be a value ranging from 5 ohms to 20 ohms, and the resistance value thereof is also set according to the material of the electronic paste, the length, width, thickness, and pattern of the heating trace, etc.

In one embodiment, for precise control over the temperature, the resistivity of the material of the second heating circuit 132 located in the heating region 13 may be set higher than the resistivity of the material of the first heating circuit 131 located in the heating region 13. Then, the second heating circuit 132 located in the heating region 13 has a higher resistance and also a better temperature coefficient of resistance (TCR) to ensure the sensitivity of the resistance to temperature variations. However, the material of the second conductive circuit 152 located in the conductive region 15 may be the same as the material of the first conductive circuit 151 located in the conductive region 15, or the materials have similar properties, and both may be a conductive material with a low resistivity, and the square resistance thereof may be less than 5 mΩ.

In the present embodiment, the second heating circuit 132 is disposed between the first heating circuits 131, which can concentrate the temperature measurement part in a high temperature interval of the heating element, and is more advantageous in precise control over the temperature.

Please refer to FIG. 6b, in combination with FIG. 6a, the first heating circuit 131 and the second heating circuit 132 are disposed in the manner shown in FIG. 6a to form four pins at the first conductive circuit 151 and second conductive circuit 152. Thus, the conductive disc 17 on the other surface of the heating film 12 includes four conductive discs corresponding to the four pins, the difference from what is shown in FIG. 5b lies in that a second positive conductive disc and a second negative conductive disc are further included, and the second positive conductive disc and the second negative conductive disc are respectively connected to one end of the second conductive circuit 152 away from the second heating circuit 132. Same as the embodiment as shown in FIG. 5b, the second positive conductive disc and the second negative conductive disc thereof are also connected with the electrode lead 19.

It will be understood that if the substrate 11 is a sheet-like substrate, the first heating circuit 131 and the second heating circuit 132, the first conductive circuit 151 and the second conductive circuit 152, and the conductive disc 17 are located on the same surface, which is the same as the above embodiment shown in FIG. 5c, and will not be described in detail herein.

In another embodiment, it may be that only one first heating circuit 131 exists and the second heating circuit 132 is located on the inner side of the first heating circuit 131, specifically as shown in FIG. 6c. Specifically, when the heating region 13, the overlapping region 14 and the conductive region 15 on one surface of the heating film 12 are specifically the embodiment as shown in FIG. 6c, the conductive disc 17 on the other surface of the heating film 12 is shown in FIG. 6b, which will not be described in detail herein.

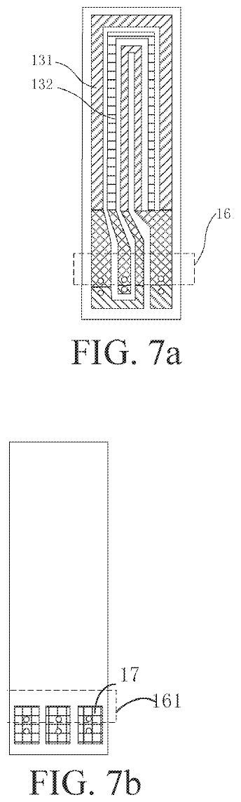

In another embodiment, the first heating circuit 131 and the second heating circuit 132 share the first positive conductive disc 171 or the second positive conductive disc, and the first heating circuit 131 and the second heating circuit 132 share the first negative conductive disc 172 or the second negative conductive disc. Specifically, please refer to FIG. 7a, one end of the first heating circuit 131 and one end of the second heating circuit 132 are connected to each other, and specifically, the first heating circuit 131 can be connected in parallel with the second heating circuit 132, namely, the positive electrode of the first heating circuit 131 is connected to the positive electrode of the second heating circuit 132, or the negative electrode of the first heating circuit 131 is connected to the negative electrode of the second heating circuit 132.

Please refer to FIG. 7b, after the first heating circuit 131 can be connected in parallel with the second heating circuit 132, three pins can be formed in the conductive region 15, and the conductive disc 17 is disposed corresponding to the pin.

In a heating assembly in the prior art, a fixing base is fixed to a conductive circuit or a heating circuit of the heating assembly, which affects the electrical connection stability of the conductive circuit and the heating circuit. However, in the heating assembly provided in the present application, the flange plate of the fixing base is installed in the overlapping region where the conductive circuit and the heating circuit of the heating assembly overlap, so as to prevent the conductive circuit or the heating circuit from being broken when the heating assembly is fixed, which ensures the electrical connection stability between the conductive circuit and the heating circuit. In addition, the heating element is provided with the heating circuit and a temperature measurement circuit, which achieves precise control over the temperature.

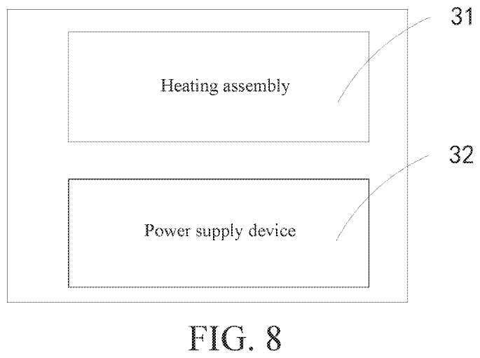

Referring to FIG. 8, it is a schematic structural diagram of one embodiment of a heating vaporization device provided by the present invention. The heating vaporization device includes a power supply device 32 and a heating assembly 31, wherein the power supply device 32 is used for supplying power to the heating assembly 31, and the heating assembly 31 is a heating assembly as described above in FIG. 1, FIG. 2, FIG. 3 and FIG. 4 and will not be described in detail herein.

The foregoing descriptions are merely implementations of the present invention, and the protection scope of the present invention is not limited thereto. All equivalent structure or process changes made according to the content of this specification and accompanying drawings in the present invention or by directly or indirectly applying the present invention in other related technical fields shall fall within the protection scope of the present invention.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A heating assembly, comprising:
a heating element comprising a substrate and a heating region, an overlapping region and a conductive region being located on the substrate and sequentially distributed in an axial direction of the substrate and connected, the heating region being provided with a heating circuit which extends to the overlapping region, and the conductive region being provided with a conductive circuit which extends to the overlapping region and is connected with the heating circuit in an overlapping manner or in parallel; and
a fixing base, one end of the fixing base fixing the heating element, the fixing base being at least partially in contact with the overlapping region.

2. The heating assembly of claim 1, wherein the substrate comprises a sheet-like substrate, or
wherein the substrate comprises a columnar substrate.

3. The heating assembly of claim 1, wherein a temperature of the overlapping region during heating is lower than a temperature of the heating region and the conductive region during heating.

4. The heating assembly of claim 1, wherein the heating circuit of the overlapping region is stacked on the conductive circuit of the overlapping region.

5. The heating assembly of claim 1, wherein the fixing base further comprises a flange plate and a base,
wherein the flange plate has a through groove at a middle position, the heating element penetrating through the through groove to fix the flange plate at least partially to the overlapping region of the heating element, the flange plate fixing the heating element to the base.

6. The heating assembly of claim 5, wherein the flange plate is completely in contact with the overlapping region.

7. The heating assembly of claim 2, wherein an outer side of the columnar substrate is wrapped with a heating film, and the heating region, the overlapping region, and the conductive region are disposed on the surface of the heating film close to the substrate,
wherein a surface of the heating film away from the substrate is provided with a conductive disc corresponding to the conductive region,
wherein, corresponding to the conductive region, the conductive disc has a through hole penetrating through the heating film, and
wherein the through hole has a conductive substance therein so as to electrically connect the conductive disc with the conductive circuit in the conductive region.

8. The heating assembly of claim 7, wherein one surface of the sheet-like substrate is provided with the heating region, the overlapping region and the conductive region, and the conductive disc,
wherein the conductive disc is located on a side of the conductive region away from the heating region.

9. The heating assembly of claim 7, wherein the heating circuit comprises a first heating circuit, the conductive circuit comprises a first conductive circuit, and the first heating circuit and the first conductive circuit coincide in the overlapping region,
wherein the first heating circuit is distributed in a U shape, and the first conductive circuit is connected to both ends of the U-shaped first heating circuit, and
wherein the conductive disc comprises a first positive conductive disc and a first negative conductive disc, the first positive conductive disc and the first negative conductive disc being respectively connected to an end of the first conductive circuit away from the first heating circuit.

10. The heating assembly of claim 9, wherein the heating circuit further comprises a second heating circuit, the conductive circuit further comprises a second conductive circuit, and the second heating circuit and the second conductive circuit coincide in the overlapping region,
wherein the second heating circuit is distributed in a U shape, and the second conductive circuit is connected to both ends of the U-shaped second heating circuit,
wherein the conductive disc comprises a second positive conductive disc and a second negative conductive disc, and
wherein the second positive conductive disc and the second negative conductive disc are respectively connected to an end of the second conductive circuit away from the second heating circuit.

11. The heating assembly of claim 10, wherein the first heating circuit comprises one circuit connected in series with the first conductive circuit, and the second heating circuit and the second conductive circuit are located on an inner side of the first heating circuit and the first conductive circuit, or
wherein the first heating circuit comprises a plurality of circuits connected in parallel with the first conductive circuit, and the second heating circuit and the second conductive circuit are located between the plurality of first heating circuits and the first conductive circuit.

12. The heating assembly of claim 11, wherein the first heating circuit and the second heating circuit share the first positive conductive disc or the second positive conductive disc, or
wherein the first heating circuit and the second heating circuit share the first negative conductive disc or the second negative conductive disc.

13. The heating assembly of claim 2, wherein the sheet-like substrate and the columnar substrate each comprise a base portion and a pointed portion located at one end of the base portion, and
wherein the heating region is close to the pointed portion.

14. The heating assembly of claim 13, wherein an end of the base portion of the columnar substrate away from the pointed portion has a groove body concaving inwards.

15. The heating assembly of claim 8, wherein a side of the heating region, the overlapping region, and the conductive region away from the substrate is provided with a covering protective layer, and
wherein the protective layer exposes a part of the conductive region.

16. The heating assembly of claim 7, wherein an end of the conductive disc away from the heating circuit is connected with an electrode lead configured to connect with a power supply device, thereby connecting the heating element with the power supply device.

17. The heating assembly of claim 8, wherein two surfaces of the sheet-like substrate are each provided with an insulating layer, and
wherein the heating region, the overlapping region and the conductive region, and the conductive disc are disposed on the insulating layer on one surface of the substrate.

18. The heating assembly of claim 7, wherein a thickness of the heating film is 0.02-0.5 mm; or
wherein the thickness of the heating film is 0.05-0.2 mm.

19. The heating assembly of claim 10, wherein a resistance of the first heating circuit is 0.5-2 ohms; and/or
wherein a resistance of the second heating circuit is 5-20 ohms.

20. The heating assembly of claim 10, wherein a resistivity of the second heating circuit located in the heating region is greater than a resistivity of the first heating circuit located in the heating region; and/or
wherein a resistance of the first heating circuit located in the conductive region is equal to a resistance of the second heating circuit located in the conductive region.

21. A heating vaporization device, comprising:
the heating assembly of claim 1; and
a power supply device,
wherein the power supply device is connected with the heating assembly so as to supply power to the heating assembly.
